(19) United States
(12) Patent Application Publication
(10) Pub. No.: US 2012/0281627 A1
(43) Pub. Date: Nov. 8, 2012

(54) METHOD AND APPARATUS FOR PROVIDING VOICE OVER INTERNET PROTOCOL SERVICE IN MOBILE COMMUNICATION SYSTEM

(75) Inventors: Yoon-Jeong Ha, Seongnam-si (KR); Han-Seok Kim, Seoul (KR); Ki-Back Kim, Seongnam-si (KR); Yeong-Moon Son, Yongin-si (KR); Han-Kyung Lee, Yongin-si (KR)

(73) Assignee: SAMSUNG ELECTRONICS CO. LTD., Suwon-si, Gyeonggi-do (KR)

(21) Appl. No.: 13/518,151

(22) PCT Filed: Dec. 21, 2010
(86) PCT No.: PCT/KR2010/009136

§ 371 Date: Jun. 21, 2012

(30) Foreign Application Priority Data
Dec. 21, 2009 (KR) 10-2009-0128500

(51) Int. Cl. H04W 40/00

(52) U.S. Cl. 370/328

(57) ABSTRACT

A method and apparatus for providing a Voice over Internet Protocol (VoIP) service using a Payload Header Suppression (PHS) method in a mobile communication system are provided. The method includes extracting header information by analyzing a Session Description Protocol (SDP) offer message that is included in a Session Initiation Protocol (SIP) signaling message received from a Worldwide Interoperability for Microwave Access (WiMAX) system, generating a Classification (CS) rule based on the extracted header information, determining whether to generate a new service flow based on the extracted header information, generating a PHS rule using a Dynamic Service Addition (DSA) when the new service flow is generated, and generating the PHS rule using a Dynamic Service Change (DSC) when the new service flow is not generated, and transmitting the generated CS rule and PHS rule to the WiMAX system.

### PRIORITY

This application is a National Stage application under 35 U.S.C. §371 of an International application filed on Dec. 21, 2010 and assigned application No. PCT/KR2010/009136, and claims the benefit under 35 U.S.C. §365(b) of a Korean patent application filed in the Korean Industrial Property Office on Dec. 21, 2009 and assigned Serial No. 10-2009-0128500, the entire disclosure of which is hereby incorporated by reference.

### BACKGROUND OF THE INVENTION

1. Field of the Invention

The present invention relates to a mobile communication system. More particularly, the present invention relates to a method and apparatus for providing a VoIP (Voice over Internet Protocol) service using a Payload Header Suppression (PHS) method in a mobile communication system.

2. Description of the Related Art

Communication systems have been developed to provide diverse services such as multimedia images, multimedia messages, and the like. In the next-generation communication systems, research for providing high-speed diverse Quality of Service (QoS) services to users is under way. Research is also under way to support high-speed services in the form of guaranteeing the mobility and QoS in a broadband wireless connection communication system such as a wireless near-field communication network system and a wireless downtown area network system. A representative communication system is a portable Internet system or a Worldwide Interoperability for Microwave Access (WiMAX) system based on the Institute of Electrical and Electronics Engineers (IEEE) 802.16 system.

The WiMAX system provides diverse services, including Voice over Internet Protocol (VoIP) service. The VoIP service is a service for transmitting voice that is carried on a packet in real time, and has been developed to emulate the existing phone service in a packet-based IP data network. In the VoIP service, call connection between a sender and a receiver is performed by the Session Initiation Protocol (SIP) and the Session Description Protocol (SDP). The SIP sets a communication path between a sender and a receiver, which is performed by Signaling System Number 7 (SS7) in the existing phone network, and the SDP defines the characteristics of packet data that is exchanged through the set communication path. If a call is set by the SIP/SDP in the VoIP service, the voice of the sender/receiver is sampled, carried on a Real Time Protocol (RTP), and then transmitted through a User Datagram Protocol/Internet Protocol (UDP/IP).

In order to guarantee the quality of the VoIP service using the RTP, a wireless network supports the QoS. However, in the case of the VoIP service, the payload in an IP packet for call is small, but the header is large to reduce the VoIP channel utility. Accordingly, in order to reduce the header of an IP packet in the IEEE 802.16 standard, a PHS method is defined so as to prearrange which portion of the IP packet is to be removed during a call setting and to exchange only the remaining portion except for the portion prearranged to be removed from the header during an actual IP packet exchange. In the IEEE 802.16 standard as described above, a predetermined portion of the overhead for the header transmission can be reduced through the PHS method, but there is an operational problem that a base station and a terminal should designate the portion to be deleted from the header of the IP packet in the PHS method. When the header of the IP packet that is used in the VoIP service in the IEEE 802.16 standard is varied in accordance with the service that is used in the terminal and the VoIP application server, a scheme for changing the PHS method in accordance with the variation has not been discussed.

Accordingly, there is a need for a scheme for efficiently changing the PHS method so that the PHS method can be applied even when the portion to be deleted from the header of the IP packet in the PHS method is not designated in detail and the header of the IP packet that is used in the VoIP service is varied in accordance with the service (that is, VoIP call) that is used in the header and the VoIP application server.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address the above-mentioned problems and/or disadvantages and to provide at least the advantages described below. Accordingly, an aspect of the present invention is to provide a method and apparatus for providing a VoIP service in a mobile communication system.

Another aspect of the present invention provides a method and apparatus for providing a VoIP service by efficiently changing a PHS method in a mobile communication system.

Another aspect of the present invention provides a method and apparatus for providing a VoIP service using an SIP signaling message so as to efficiently apply a PHS method in a mobile communication system.

In accordance with an aspect of the present invention, a method of providing a Voice over Internet Protocol (VoIP) service in a terminal of a mobile communication system is provided. The method includes extracting header information by analyzing a Session Description Protocol (SDP) offer message that is included in a Session Initiation Protocol (SIP) signaling message received from a Worldwide Interoperability for Microwave Access (WiMAX) system, generating a Classification (CS) rule based on the extracted header information, determining whether to generate a new service flow based on the extracted header information, and generating a Payload Header Suppression (PHS) rule using a Dynamic Service Addition (DSA) in the case where the new service flow is generated, and generating the PHS rule using a Dynamic Service Change (DSC) when the new service flow is not generated, and transmitting the generated CS rule and PHS rule to the WiMAX system.

In accordance with another aspect of the present invention, an apparatus for providing a VoIP service in a terminal of a mobile communication system is provided. The apparatus includes an application unit for receiving an SIP signaling message from a WiMAX system, and for extracting an SDP offer message that is included in the received SIP signaling message, a CS/PHS rule generator for extracting header information by analyzing the extracted SDP offer message, for generating a CS rule based on the extracted header information, for determining whether to generate a new service flow based on the extracted header information, for generating a Payload Header Suppression (PHS) rule using a Dynamic Service Addition (DSA) when the new service flow is generated, and for generating the PHS rule using a DSC when the new service flow is not generated, and a WiMAX modem for transmitting the generated CS rule and PHS rule to the WiMAX system.

According to aspects of the present invention, the PHS method can be efficiently changed by applying the PHS rule in accordance with the service that is used in the VoIP service.

According to additional aspects of the present invention, the VoIP service packet utility can be improved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 is a diagram illustrating the configuration of a terminal that generates a Classification/Payload Header Suppression (CS/PHS) rule in a mobile communication system according to an exemplary embodiment of the present invention;

FIG. 2 is a diagram illustrating a method of generating a PHS rule in a terminal according to an exemplary embodiment of the present invention; and

FIG. 3 is a diagram illustrating a method of generating a CS/PHS rule in a terminal of a mobile communication system according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention generate a Classification/Payload Header Suppression (CS/PHS) rule using an SIP signaling message so as to efficiently apply a PHS method when a header of an IP packet is changed in accordance with a VoIP call. A method and apparatus for generating a CS/PHS rule using an SIP signaling message in a mobile communication system according to exemplary embodiments of the present invention are described below.

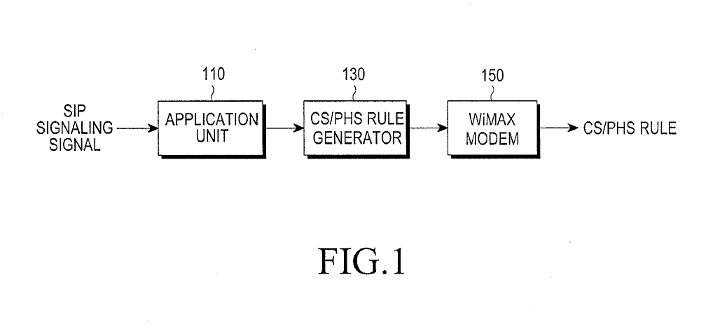

FIG. 1 is a diagram illustrating the configuration of a terminal that generates a CS/PHS rule in a mobile communication system according to an exemplary embodiment of the present invention.

Referring to FIG. 1, the terminal includes an application unit 110, a CS/PHS rule generator 130, and a WiMAX modem 150.

The application unit 110 receives an SIP signaling message from the WiMAX system, extracts an SDP offer message included in the received SIP signaling message, and transfers the extracted SDP offer message to the CS/PHS rule generator 130.

The CS/PHS rule generator 130 extracts header information included in the SDP offer message by analyzing the SDP offer message transferred from the application unit 110. The header information includes at least one of an IP address of a transmitting end/receiving end, a port of the transmitting end/receiving end, a protocol, a Type of Service (ToS) field, and a flow label.

The CS/PHS rule generator 130 sets a CS rule that can efficiently divide the transmitting end and the receiving end as the minimum set using the extracted header information. A system operator can select which Threshold Limit Value (TLV) is used as the CS rule.

The CS/PHS rule generator may also determine whether to generate a new service flow that is needed to transmit/receive the VoIP service packet using the extracted header information. The CS/PHS rule generator 130 generates the PHS rule using the Dynamic Service Addition (DSA) if the new service flow is needed, and generates the PHS rule using the Dynamic Service Change (DSC) if the new service flow is not needed.

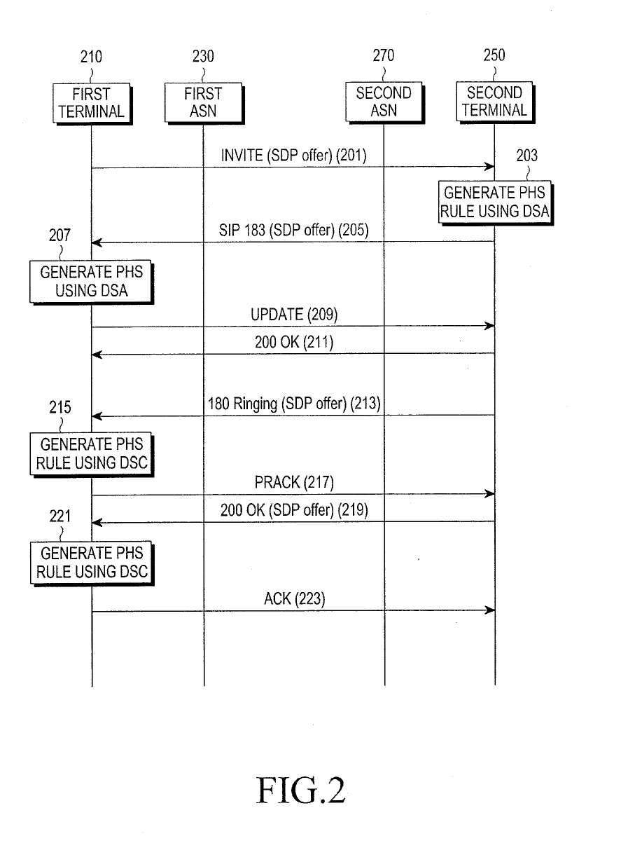

For example, as illustrated in FIG. 2, the CS/PHS rule generator 130 may generate the PHS rule using the SIP signaling message.

FIG. 2 is a diagram illustrating a method of generating a PHS rule in a terminal according to an exemplary embodiment of the present invention.

Referring to FIG. 2, in step 201, a first terminal 210, if it is intended to execute the VoIP service, transmits an invite message that includes an SDP offer message to a second terminal 250 through a first Access Service Network (ASN) 230 and a second ASN 270 of the WiMAX system. In step 203, the second terminal 250 receives the invite message transmitted from the second ASN 270, and extracts the head information by analyzing the SDP offer message that is included in the invite message. Since the SDP offer message is included in the invite message indicating an intention to start the VoIP service from the first terminal 210 to the second terminal 250, the SDP offer message includes header information for generating a new service flow. Accordingly, the second terminal 250 determines a new service flow should be generated through the extracted header information, and then generates the PHS rule using the DSA.

In step 205, the second terminal 250 transmits a session proceeding (SIP 183) message that includes the SDP offer message to the first terminal 210 through the second ASN 270 and the first ASN 230. In step 207, the first terminal 210 receives the SIP 183 message transmitted from the first ASN 230, and extracts the header information by analyzing the SDP offer message since the SDP offer message is included in the received SIP 183 message. Since the SDP offer message included in the SIP 183 message is included in the session proceeding message for starting the VoIP service from the second terminal 250 to the first terminal 210, the SDP offer message includes the header information for generating a new service flow. Accordingly, the first terminal 210 determines a new service flow should be generated through the extracted header information, and then generates the PHS rule using the DSA.

In step 209, the first terminal 210 transmits an update message for the VoIP service to the second terminal 250, and the second terminal 250, which has received the update message in step 211, transmits a response (200 OK) message to the first terminal 210.

Thereafter, if the second terminal 250 transmits a call (180 Ringing) message that includes the SDP offer message to the first terminal 210 through the second ASN 270 and the first ASN 230 in step 213, the first terminal 210, which has received the 180 Ringing message in step 215, extracts the SDP message by analyzing the SDP offer message included in the received 180 Ringing message in step 215. The SDP offer message included in the 180 Ringing message does not include the header information for generating a new service flow since the SDP offer message is transmitted after the invite message of the SIP 183 message. The SDP offer message transmitted in step 213 includes header information that is similar to the previously transmitted SDP offer message. Accordingly, the first terminal 210 determines that a new service flow is not generated through the extracted header information, and then generates the PHS rule using the DSA. In step 217, the first terminal 210 transmits a Provisional Response ACKnowledgement (PRACK) message to the 180 Ringing message to the second terminal 250.

If the second terminal 250 transmits a call release response message (200 OK) that includes the SDP offer message through the second ASN 270 and the first ASN 230 in step 219, the first terminal 210, which has received the 200 OK message, extracts the header information by analyzing the SDP offer message included in the received 200 OK message in step 221. Since the SDP offer message included in the 200 OK message is transmitted after the 180 Ringing message, the SDP offer message does not include the header information for generating a new service flow. Accordingly, the first terminal 210 determines that a new service flow is not generated through the extracted header information, and then generates the PHS rule using the DSC. In step 223, the first terminal 210 transmits a response (ACK) message to the 200 OK message to the second terminal 250.

Accordingly, the CS/PHS rule generator 130 that is included in the first terminal 210 and the second terminal 250 generates the PHS rule using the DSA in the case where a new service flow is generated based on the header information included in the transmitted SIP signaling message, and generates the PHS rule using the DSC in the case where the generated service flow is changed or added. In this case, the CS/PHS rule generator 130 newly generates or changes the PHS rule in the case where the header information is changed through the SIP signaling message such as SIP invite/SIP 183, SIP 180 Ringing/SIP 200 OK.

Referring to FIG. 1, the CS/PHS rule generator 130 generates a new PHS rule and a Payload Header Suppression Index (PHSI) using the DSA if it is determined that a new flow is generated as described above. The CS/PHS rule generator 130 indicates that a PHS rule is newly generated by setting the PHS DSC action rule of the PHS rule to “1”, and includes the extracted header information in the PHSI and offer message. Accordingly, the CS/PHS rule generator 130 transfers a CS rule [information on a transmitting end/receiving end in header information+(CS rule index, PHSI)]+a PHS rule [PHS DSC action rule (1=set)+(PHSI, header information)] to the WiMAX modem 150. If there are plural header information extracted from the SDP offer message, the CS/PHS rule generator 130 extracts the PHS rule using the DSC action rule (1=add). The CS/PHS rule generator 130 adds a CS rule [information on a transmitting end/receiving end in header information+(CS rule index, PHSI)]+a PHS rule [PHS DSC action rule (0=add)+(PHSI, header information)] to the CS rule [information on a transmitting end/receiving end in header information+(CS rule index, PHSI)]+the PHS rule [PHS DSC action rule (1=set)+(PHSI, header information)], and transfers the result of addition to the WiMAX modem 150.

On the other hand, in the current IEEE 802.16 standard, the terminal is prohibited from generating the PHSI, and thus the CS/PHS rule generator 130 may prearrange the PHSI for the PHS rule initially generated using the DSA as “1” and an arbitrary value with the base station. The CS/HS rule generator 130 may determine the PHSI for the added PHS rule as PHSI+1 currently used, and update the PHSI to the PHSI that the base station transmits to the RSP later. When the PHSI cannot be generated, the terminal and the system should operate under the assumption that the relationship between the CS rule and the PHS rule corresponds to a combination of the CS rule and the PHS rule that just follows the CS rule. If the terminal transmits [CS rule 1][PHS rule 1][CS rule 2][PHS rule 2] to the system, the system should index the CS rule 1 and the PHS rule 1 into the same PHSI. In other words, if the PHSI of the PHS rule 1 is generated as “1”, A.PHSI of the CS rule 1 becomes “1”, and if the PHSI of the PHS rule 2 is generated as “2”, A.PHSI of the CS rule 2 should be mapped onto “2”. Here, the system includes the PHSI and CS rule index values in the DSA/DSC response.

According to exemplary embodiments of the present invention, if it is determined that the new flow is not generated as described above, the CS/PHS rule generator 130 changes the PHS rule using the DSC. The CS/PHS rule generator 130 recommends changing the PHS rule using the DSC in order to dynamically change the PHS rule even in the case of the service flow generated through the DSA in a PCRF (Policy and Charging Rules Function) or the base station.

The CS/PHS rule generator 130 generates a classifier DSC action rule and a PHS DSC action rule in order to change the PHS rule. That is, in the case of adding a new CS rule or PHS rule, the CS/PHS rule generator 130 sets DSC action rule=0(add) and PHS DSC action rule=0(add). When changing the previously set CS rule or PHS rule, the CS/PHS rule generator 130 sets classifier DSC action rule=1(replace) and PHS DSC action rule=1(set).

However, when changing the PHS rule previously set in the current IEEE 802. 16 standard, the setting of PHS DSC action rule=1(set) is defined as an error process, and thus the CS/PHS rule generator 130 sets PHS DSC action rule=0(add) even when changing the PHS rule previously set in order to observe the standard, and deletes all PHS rules when the service flow is deleted. As another method, the CS/PHS rule generator 130 may delete the service flow by setting the PHS DSC action rule as 2(delete) or 3(delete all), and may set PHS DSC action rule=0(set).

When adding a new CS rule or PHS rule as the PHSI and CS rule index, the CS/PHS rule generator 130 generates PHSI+1/CS rule index+1, and uses the existing index when changing the rule.

Accordingly, when changing the PHS rule using the DSC, the CS/PHS rule generator 130 transmits the CS rule [information on a transmitting end/receiving end in header information+(CS rule index, PHSI)+Classifier DSC action rule]+the PHS rule [PHS DSC action rule (1=set)+(PHSI, header information)] to the WiMAX modem 150.

In the current IEEE 802. 16 standard, the terminal is prohibited from generating the PHSI, and thus the CS/PHS rule generator 130 may determine PHSI for the added PHS rule as PHSI+1 using the DSC, and then updates the PHSI to the PHSI that the base station transmits to the RSP later. The CS/PHS rule generator 130 can delete the unused PHS rule and CS rule. In this case, the CS/PHS rule generator 130 deletes the unused CS rule index/PHSI and PHS DSC action rule by setting them to “delete”.

The WiMAX modem 150 transmits the CS rule and the PHS rule transferred from the CS/PHS generator 130 to the WiMAX system.

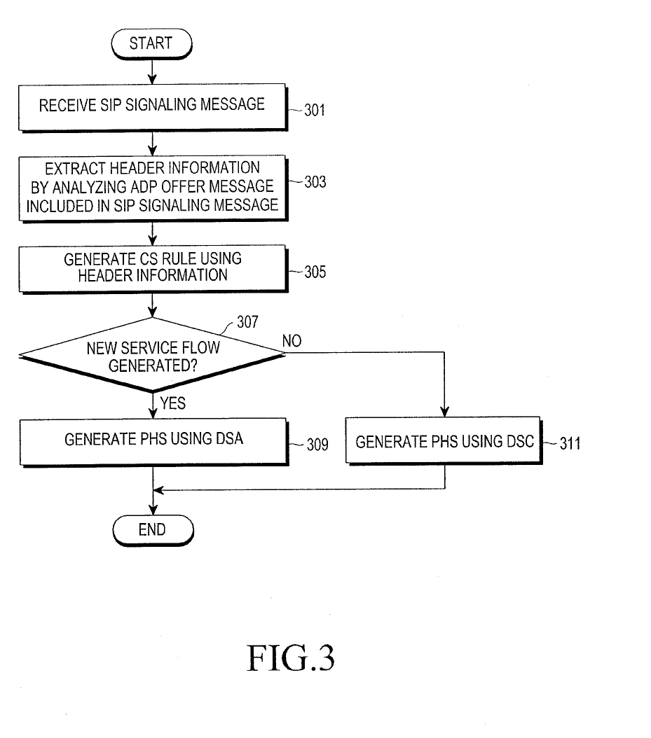

FIG. 3 is a diagram illustrating a method of generating a CS/PHS rule in a terminal of a mobile communication system according to an exemplary embodiment of the present invention.

Referring to FIG. 3, in step 301, the CS/PHS rule generator 130 of the terminal receives an SDP offer message included in the SIP signaling message from the application unit 110. In step 303, the CS/PHS rule generator 130 extracts header information by analyzing the SDP offer message. The header information includes at least one of an IP address of a transmitting end/receiving end, a port of the transmitting end/receiving end, a protocol, a ToS field, and a flow label.

In step 305, the CS/PHS rule generator 130 sets the CS rule that can efficiently divide the transmitting end and the receiving end as the minimum set using the extracted header information.

In step 307, the CS/PHS rule generator 130 determines whether to generate a new service flow that is required to transmit/receive the VoIP service packet using the extracted header information to generate the PHS rule. If the new service flow is generated as a result of the determination, the CS/PHS rule generator 130 proceeds to step 309, while if not, the CS/PHS rule generator 130 proceeds to step 311.

In step 309, the CS/PHS rule generator 130 generates a new PHS rule and PHSI using the DSA. The CS/PHS rule generator 130 transfers the CS rule [information on a transmitting end/receiving end in header information+(CS rule index, PHSI)]+the PHS rule [PHS DSC action rule (1=set)+(PHSI, header information)] to the WiMAX modem 150. Accordingly, the PHS method can be efficiently changed using the DSA through the header information included in the SDP offer message according to the VoIP call that is used in the VoIP service.

In step 311, the CS/PHS rule generator 130 generates a classifier DSC action rule and a PHS DSC action rule to change the PHS rule previously generated using the DSC. Accordingly, the CS/PHS rule generator 130 transmits the CS rule [information on a transmitting end/receiving end in header information+(CS rule index, PHSI)]+the PHS rule [PHS DSC action rule+(PHSI, header information)] to the WiMAX modem 150. Accordingly, the PHS method may be efficiently changed using the DSC through the header information included in the SDP offer message according to the VoIP call that is used in the VoIP service.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method of providing a Voice over Internet Protocol (VoIP) service in a terminal of a mobile communication system, the method comprising:
extracting header information by analyzing a Session Description Protocol (SDP) offer message that is included in a Session Initiation Protocol (SIP) signaling message received from a Worldwide Interoperability for Microwave Access (WiMAX) system;
generating a Classification (CS) rule based on the extracted header information;
determining whether to generate a new service flow using the extracted header information, and generating a Payload Header Suppression (PHS) rule using a Dynamic Service Addition (DSA) when the new service flow is generated, and generating the PHS rule using a Dynamic Service Change (DSC) when the new service flow is not generated; and
transmitting the generated CS rule and PHS rule to the WiMAX system.

2. The method as claimed in claim 1, wherein the header information includes at least one of an IP address of a transmitting end/receiving end, a port of the transmitting end/receiving end, a protocol, a ToS field, and a flow label.

3. The method as claimed in claim 1, wherein the CS rule includes information on a transmitting end and a receiving end included in the header information, a CS rule index, and a PHS rule index.

4. The method as claimed in claim 1, wherein the PHS rule includes a PHS DSC action rule, a PHS rule index, and the header information.

5. The method as claimed in claim 4, wherein the generating of the PHS rule comprises setting the PHS DSC action rule to “1(set)” based on the DSA when generating the new service flow.

6. The method as claimed in claim 4, wherein the generating of the PHS rule comprises:
determining whether a new PHS rule is added or the previously set PHS rule is changed based on the DSC when the new service flow is not generated;
setting the PHS DSC action rule to “0(add)” when the new PHS rule is added; and
setting the PHS DSC action rule to “1(set)” when the previously set PHS rule is changed.

7. An apparatus for providing a Voice over Internet Protocol (VoIP) service in a terminal of a mobile communication system, the apparatus comprising:
an application unit for receiving a Session Initiation Protocol (SIP) signaling message from a Worldwide Interoperability for Microwave Access (WiMAX) system, and for extracting a Session Description Protocol (SDP) offer message that is included in the received SIP signaling message;
a CS/PHS rule generator for extracting header information by analyzing the extracted SDP offer message, for generating a Classification (CS) rule based on the extracted header information, for determining whether to generate a new service flow based on the extracted header information, for generating a Payload Header Suppression (PHS) rule based a Dynamic Service Addition (DSA) when the new service flow is generated, and for generating the PHS rule using a Dynamic Service Change (DSC) when the new service flow is not generated; and
a WiMAX modem for transmitting the generated CS rule and PHS rule to the WiMAX system.

8. The apparatus as claimed in claim 7, wherein the header information includes at least one of an IP address of a transmitting end/receiving end, a port of the transmitting end/receiving end, a protocol, a ToS field, and a flow label.

9. The apparatus as claimed in claim 7, wherein the CS rule includes information on a transmitting end and a receiving end included in the header information, a CS rule index, and a PHS rule index.

10. The apparatus as claimed in claim 7, wherein the PHS rule includes a PHS DSC action rule, a PHS rule index, and the header information.

11. The apparatus as claimed in claim 10, wherein the CS/PHS rule generator sets the PHS DSC action rule to “1(set)” using the DSA in the case of generating the new service flow.

12. The apparatus as claimed in claim 10, wherein the CS/PHS rule generator determines whether a new PHS rule is added or the previously set PHS rule is changed based on the DSC when the new service flow is not generated, sets the PHS DSC action rule to “0(add)” when the new PHS rule is added, and sets the PHS DSC action rule to “1(set)” when the previously set PHS rule is changed.

13. The apparatus as claimed in claim 12, wherein the CS/PHS rule generator sets a classifier DSC action rule to “1(replace)” when the previously set PHS rule is changed.

14. The method as claimed in claim 6, further comprising setting a classifier DSC action rule to “1(replace)” when the previously set PHS rule is changed.
